(19) United States
(12) Patent Application Publication
(10) Pub. No.: US 2016/0269837 A1
(43) Pub. Date: Sep. 15, 2016

(54) HEARING AID

(71) Applicant: SIVANTOS PTE. LTD., Singapore (SG)

(72) Inventor: JOHANNES KUHN, ERLANGEN (DE)

(21) Appl. No.: 15/067,406

(22) Filed: Mar. 11, 2016

(30) Foreign Application Priority Data
Mar. 11, 2015 (DE) 102015204393.2

(51) Int. Cl. H04R 25/00

(52) U.S. Cl. CPC H04R 25/602; H04R 2225/021

(57) ABSTRACT

A hearing aid contains a housing with an integrated battery compartment for reversibly receiving a battery. The hearing aid further contains a battery compartment door for reversibly closing the battery compartment. The battery compartment door has a sealing and closing contour, which is formed integrally thereon in one piece and which has increased flexibility compared to the housing and, in the closed state of the battery compartment door, is in preferably fluid-tight contact with the edge of the battery compartment and provides a holding action.

### CROSS-REFERENCE TO RELATED APPLICATION

This application claims the priority, under 35 U.S.C. §119, of German application DE 10 2015 204 393.2, filed Mar. 11, 2015; the prior application is herewith incorporated by reference in its entirety.

### BACKGROUND OF THE INVENTION

### Field of the Invention

The invention relates to a hearing aid. The hearing aid is configured in particular as a so-called behind-the-ear hearing aid and, during use, is thus worn behind an ear of the person wearing the hearing aid.

Hearing aids are conventionally used by persons with impaired hearing in order to at least partly compensate for this reduction in their hearing. For this purpose, each hearing aid usually contains at least a microphone for picking up sound signals (i.e. in particular speech and also other noises from the environment) and a loudspeaker (often also called a “receiver”) for forwarding the picked-up sound signals to an ear of the person wearing the hearing aid. Moreover, the hearing aid generally has a control unit (often referred to as a “signal processor”) which is connected between the microphone and the loudspeaker and by which the sound signals detected by the microphone are amplified (mostly in a frequency-dependent manner), attenuated (in some cases also completely faded out), filtered and/or compressed. The sound signals that are processed in this way are then forwarded from the control unit to the loudspeaker. The microphone, the loudspeaker and the control unit are generally installed in a housing of the hearing aid.

As is known, the microphone, the control unit and the loudspeaker each form an electronic component that requires a supply of energy during the operation of the hearing aid. The energy source used in hearing aids is often a battery. For the hearing aid itself to be made as small as possible (and therefore inconspicuous) and with a low weight, the batteries used are mostly in the form of button cells, particularly in the form of zinc-air batteries. Since each battery is known to have a limited useful life, i.e. is able to supply energy only over a limited period of time, the hearing aid expediently has a battery compartment that can be reversibly opened and closed in order to replace the battery. The particularly small dimensions of the batteries used also means that their useful life is relatively short. Therefore, for reasons of saving energy, hearing aids should be switched off when not in use (for example when the person wearing the hearing aid is sleeping). However, in order to simplify the handling of the hearing aid by arranging the smallest possible number of switches on its housing, or indeed no switches at all, the hearing aid is in most cases switched off by removing the battery from the battery compartment, or by the battery being pulled out from the battery compartment at least until the current circuit is interrupted.

To permit the reversible closure of the battery compartment, hearing aids usually have a cover (referred to hereinbelow as the battery compartment door). These battery compartment doors are usually fixed in their closed position on the housing by a locking element. To permit opening, the locking element then first of all has to be separately unlocked. However, because of the size of the hearing aids, and therefore also of the battery compartment doors, the handling of the hearing aids, in particular of the battery compartment doors, is thus made difficult.

### SUMMARY OF THE INVENTION

The object of the invention is to make available a hearing aid that is easier to operate.

The hearing aid according to the invention contains a housing for accommodating (electronic) hearing aid components, for example a microphone, a control unit for processing sound signals detected by the microphone, and also, if appropriate, a loudspeaker. The hearing aid further contains a battery compartment for receiving, preferably reversibly, a battery which serves to supply energy to the hearing aid components when the hearing aid is in operation. The battery compartment is worked into the housing, for example in the shape of a slot, or as a free cutting in a wall of the housing (“housing wall”) and thus forms a kind of “garage” for the battery. Moreover, the hearing aid contains a battery compartment door for reversibly closing the battery compartment. The battery compartment door has a sealing and closing contour which, in the closed state of the battery compartment door, is in contact with the edge of the battery compartment and provides a holding action with the housing. The sealing and closing contour has increased flexibility (i.e. reduced stiffness) compared to the housing, and, in addition, is produced in one piece with the battery compartment door, in other words from the same material as the battery compartment door and integrally therewith.

Since the sealing and closing contour itself already provides a holding action with the housing, in the area of its preferably overlapping contact with the edge of the battery compartment, it is advantageously possible to dispense with an additional and separate closure mechanism, in particular a locking element such as a pawl or a snap-action hook, which keeps the battery compartment door in the closed state on the housing and which in particular has to be separately unlocked to permit opening. Thus, the handling of the battery compartment door, and also of the hearing aid, is thereby improved. Moreover, the fact that the sealing and closing contour is formed integrally on the battery compartment door permits particularly simple and cost-effective production of the battery compartment door.

The holding action is effected, for example, by a mechanical locking of the sealing and closing contour to the edge of the battery compartment, but preferably by a force-fit engagement between the edge of the battery compartment and the sealing and closing contour (i.e. on account of a frictional force and/or clamping force).

Moreover, in the closed state, the sealing and closing contour is preferably in almost fluid-tight contact with the housing. Here, and in the description below, “almost fluid-tight” is understood as meaning that the risk of perspiration, in particular, getting into the housing is virtually excluded or at least reduced, such that fault-free operation of the hearing aid is permitted, advantageously without additional, separate sealing elements being required.

In the context of the invention, however, it is also conceivable that the battery compartment door contains an additional latch element for supporting the holding action of the sealing and closing contour. For example, this latch element is configured to cooperate with a corresponding mating piece, arranged on the housing of the hearing aid, in such a way that no separate operation of the latch element is needed when opening and closing the battery compartment door. Rather, when the latch element is engaged in or disengaged from its latching position, an elastic deformation of the latch element takes place in particular, which is effected solely by the opening or closing force exerted on the battery compartment door.

Preferably, the battery compartment door also has a bearing element, by which the battery compartment door is mounted (movably) on the housing in the correct state of assembly. For example, this bearing element is part of a pivot joint, which is expediently formed by an eye through which, in the correct state of assembly of the battery compartment door on the housing, a bearing pin (as the other part of the pivot joint) is inserted in order to form a connection to the housing. The eye (in particular the axis thereof) forms a pivot point for the pivoting movement of the battery compartment door during opening and closing. In order to permit a sufficiently great pivoting radius of the battery compartment door during opening and closing, the bearing element is preferably a “bearing rocker”, i.e. an extension piece which is elongate (in relation to its width) and protrudes from a front portion of the battery compartment door. The above-described eye is preferably formed in turn at the (free) end of this extension piece. In the closed state, the front portion of the battery compartment door in particular forms a front closure for the battery compartment.

In a preferred embodiment of the hearing aid, the battery compartment door is made from a material that is less stiff than the material of the housing and, in particular, softer. The material of the battery compartment door preferably has a lower Shore hardness, the latter being chosen to provide a sufficient geometric stability of the battery compartment door. The material of the housing is preferably acrylonitrile butadiene styrene (ABS) copolymer or a plastic with comparable (material) stiffness. By contrast, the material of the battery compartment door is, for example, low-density polyethylene (PE-LD), heat-curing silicone (preferably a silicone with a relatively high degree of stiffness for elastomers) or, in particular, a thermoplastic elastomer. The reduced stiffness or increased flexibility of the battery compartment door by comparison with the housing is thus provided by the material. Since the battery compartment door and therefore also the sealing and closing contour are made from the comparatively soft material, the sealing and closing contour nestles tightly, in a particularly simple way, on the edge of the battery compartment in the closed state of the battery compartment door, such that a particularly good sealing action is obtained between the sealing and closing contour and the edge of the battery compartment. It is therefore advantageously possible to dispense with additional sealing elements (separately produced from a special elastomer) for sealing off the (closed) battery compartment door in relation to the housing, and the costs of the hearing aid are further reduced. Thus, in this embodiment, the hearing aid preferably has no sealing elements (produced from a third material) which serve to seal off the battery compartment door in relation to the housing.

In an alternative embodiment, the battery compartment door (and therefore also the sealing and closing contour) is made from the same material as the housing. The flexibility of the sealing and closing contour is in this case preferably increased by having a reduced wall thickness compared to the housing. This means, on the one hand, that the sealing and closing contour has a sufficient elastic deformability in order to be deformed relative to the edge of the battery compartment and provide the holding action during closure. On the other hand, this also means that (in the closed state of the battery compartment door) the hearing aid has a particularly uniform appearance, particularly since in this case the optical properties of the material used for the housing and the battery compartment door are the same.

In a preferred embodiment of the hearing aid, the sealing and closing contour, in the closed state of the battery compartment door, bears on the housing, in particular on the edge of the battery compartment, in the manner of an interference fit. In other words, the geometrical dimensions of the housing and of the sealing and closing contour overlap slightly, with the result that the more flexible sealing and closing contour deforms elastically during closure of the battery compartment door. The sealing and closing contour thus forms a kind of press fit with the housing. In this way, the frictional and/or clamping force required to provide the (form-fit) holding action between the sealing and closing contour and the edge of the housing (or battery compartment) is advantageously increased. Moreover, the sealing action between the sealing and closing contour and the edge of the battery compartment is increased by this form-fit connection. This embodiment is particularly advantageous also in connection with the battery compartment door produced from softer plastic, since in this case the sealing and closing contour is known to have a comparatively high elastic deformation capacity and generally also a higher tensile strength with respect to repeated deformations. In other words, the battery compartment door produced from softer plastic can be opened and closed frequently, without the battery compartment door itself and/or the housing being damaged. Moreover, the coefficient of friction between a softer plastic (in particular an elastomer) and a harder plastic is often high, such that the holding action is additionally strengthened. To allow the sealing and closing contour and the edge of the battery compartment to easily slide over each other during closure of the battery compartment door, particularly in the case of the interference fit, a margin of the sealing and closing contour that is intended to come first into contact with the edge of the battery compartment during closure of the battery compartment door is rounded or beveled. In the latter case, the sealing and closing contour thus preferably has at its edge a bevel which, during closure, serves as a slide-on slope with respect to the edge of the battery compartment.

In addition to the interference fit (present in the closed state of the battery compartment door), it is also conceivable, within the context of the invention, that the housing and the sealing and closing contour each have a complementary undercut (for example, on the one hand a groove and on the other hand a bead), by which, in addition to the force-fit connection, a mechanical locking (a form-fit connection) of the battery compartment door on the housing and an enhanced sealing action are also permitted.

In a particularly preferred embodiment, at least the sealing and closing contour, but preferably also the housing, has a rabbet, i.e. a shoulder or a step as seen in the wall thickness direction. In the closed state of the battery compartment door, this rabbet forms a so-called scarf joint (a stepped overlapping) of the sealing and closing contour with the housing. The or each rabbet is in particular configured in such a way that that battery compartment door joins the housing smoothly (i.e. steplessly at the transition). Moreover, the entire contact surface between the sealing and closing contour and the edge of the battery compartment is thus (multi) angled, such that a creepage path for liquids is increased and the sealing action is thereby improved.

In an expedient embodiment, the battery compartment door is configured substantially like a clip or U-shaped. In the closed state of the battery compartment door, the (above-described) front portion closes off the housing and thus the hearing aid at one of its ends. The front portion lies in a cross-sectional plane of the housing, wherein the cross section extends in the thickness direction, and forms the “floor” of the U (or the cross-piece of the clip). Two grip wings, which form the two (parallel) long branches of the U, extend substantially (i.e. exactly or approximately) perpendicularly from this front portion. In the closed state of the battery compartment door, the grip wings are oriented in the surface direction of the housing, in particular on the same plane as the upper and lower housing wall thereof. The grip wings each advantageously form a sufficiently large gripping surface area, in particular for the thumb and index finger of the person wearing the hearing aid, such that the battery compartment door can be gripped and operated particularly easily. Moreover, at their edge directed away from the front portion, the grip wings carry the sealing and closing contour. Upon closure of the battery compartment door, the two grip wings are pushed at least partially, i.e. with the sealing and closing contour, onto the housing or alternatively pushed into the housing. In the case where the battery compartment door is produced from the same material as the housing (in particular ABS), the whole grip wings, or at the very least the sealing and closing contour, are advantageously configured with a wall thickness that is reduced in relation to the housing wall.

In a particularly expedient embodiment, the grip wings are arranged substantially parallel to each other and at such a distance from each other that the battery to be used with the hearing aid is held by a clamping action between the grip wings. That is to say, the distance of the two grip wings from each other (seen in the thickness direction of the housing) is the same as or preferably slightly less than the thickness (also called the height) of the battery. Particularly in this case, in addition to providing the sufficiently large gripping surface area for the operation of the battery door, the grip wings preferably also serve to automatically pull the battery out of the battery compartment upon opening of the battery compartment door and thereby to automatically switch off the hearing aid. As a result of the clamping action of the two grip wings on the battery, additional holding elements for the battery can be dispensed with, and the hearing aid and the battery compartment door can be produced easily and cost-effectively.

In another advantageous embodiment, an interior of the battery compartment door formed between the grip wings is configured in such a way that the battery can be pushed into the interior with a clear orientation of its polarity. For this purpose, a shoulder is preferably formed at an inner transition (i.e. facing toward the interior) from the front portion to one of the two grip wings. The battery is preferably a button cell which, at the transition to one of its flat faces that at the same time forms one of its poles, in particular the negative pole, has a constriction or a “neck” (which is relatively short compared to the height of the button cell), i.e. a reduction of its diameter. In the correct state of insertion of the button cell in the interior of the battery compartment door, the shoulder lies in the constriction or neck of the button cell, such that the button cell, pushed completely into the interior, can lie with its circumferential surface on the inner face of the front portion. By contrast, if the button cell is pushed into the interior of the battery compartment door inverted about its surface plane, in other words “the wrong way round”, the button cell lies with its wider flat face (“bottom face”, hereinafter designated simply as bottom piece) on the shoulder of the battery compartment door and, as a result, cannot be pushed sufficiently far into the interior of the battery compartment door. A wrongly inserted battery can thus be advantageously recognized in a simple way, particularly since in this case the battery compartment door cannot be fully closed, on account of the button cell not being able to be pushed in sufficiently far.

In another expedient embodiment, the grip wings, in their longitudinal extent, are shorter than the diameter of the battery, configured preferably as a button cell. In this case, even when correctly oriented, the button cell placed in the interior of the battery compartment door always protrudes above the grip wings, such that the positive pole and also the negative pole of the button cell are not covered by the grip wings. Upon closure of the battery compartment door, both poles can thus be contacted in a simple way by corresponding electrical contacts, which are arranged on the inner face of the housing in the battery compartment. The “length” of the grip wings is preferably smaller than the diameter of the button cell but greater than the radius thereof. The button cell, when inserted (in the correct orientation), preferably protrudes by about a third or a quarter of its diameter above the two grip wings. Particularly in combination with the clamping preferably applied by the grip wings, the inserted button cell is thus mounted in the battery compartment door in a manner stable against tilting and advantageously secure against loss.

The button cell to be used with the hearing aid is preferably a button cell designed as a zinc air battery. In such a button cell, a chemical reaction of zinc with (atmospheric) oxygen is utilized to provide energy. For this purpose, the corresponding button cell has, at one of its poles, a number of air inlet openings for admitting oxygen. In a particularly expedient embodiment, in order to permit sufficient ventilation of the air inlet openings of this pole, a back ventilation device is arranged on the inner face of the grip wing that is intended to be directed toward the corresponding pole. The back ventilation device is in particular configured in such a way that the flat face of the button cell forming the corresponding pole (in particular the area of the flat face covered by the respective grip wing) does not bear completely on the inner face of this grip wing. The back ventilation device is preferably in the form of one or more ribs and/or punctiform elevations which are applied on the inner face of the grip wing. However, within the context of the invention, these means can accordingly also be grooves or “dents” in the inner face of the grip wing, which permit equivalent ventilation of the corresponding pole. The pole of the button cell provided with the air inlet openings is customarily the positive pole, i.e. the cathode. The cathode is in particular arranged on the bottom piece of the button cell. In the case where the battery compartment door has the above-described shoulder for correct orientation of the button cell, the back ventilation means are thus formed on the grip wing that lies opposite the shoulder.

Other features which are considered as characteristic for the invention are set forth in the appended claims.

Although the invention is illustrated and described herein as embodied in a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a hearing aid;

FIG. 2 is a diagrammatic, perspective view of a battery compartment door of the hearing aid;

FIG. 3 is a perspective view of a section of a battery compartment with the battery compartment door partially opened;

FIG. 4 is a perspective view in accordance with FIG. 2 of the battery compartment door with a battery inserted;

FIG. 5 is a perspective view of an inner face of the battery compartment door, respectively without an inserted battery;

FIG. 6 is a front view showing the inner face of the battery compartment door, respectively with the inserted battery; and

FIGS. 7 and 8 are perspective views showing, in a view in accordance with FIG. 2, two further alternative illustrative embodiments of the battery compartment door.

### DETAILED DESCRIPTION OF THE INVENTION

Parts corresponding to one another are always provided with the same reference signs in all the figures.

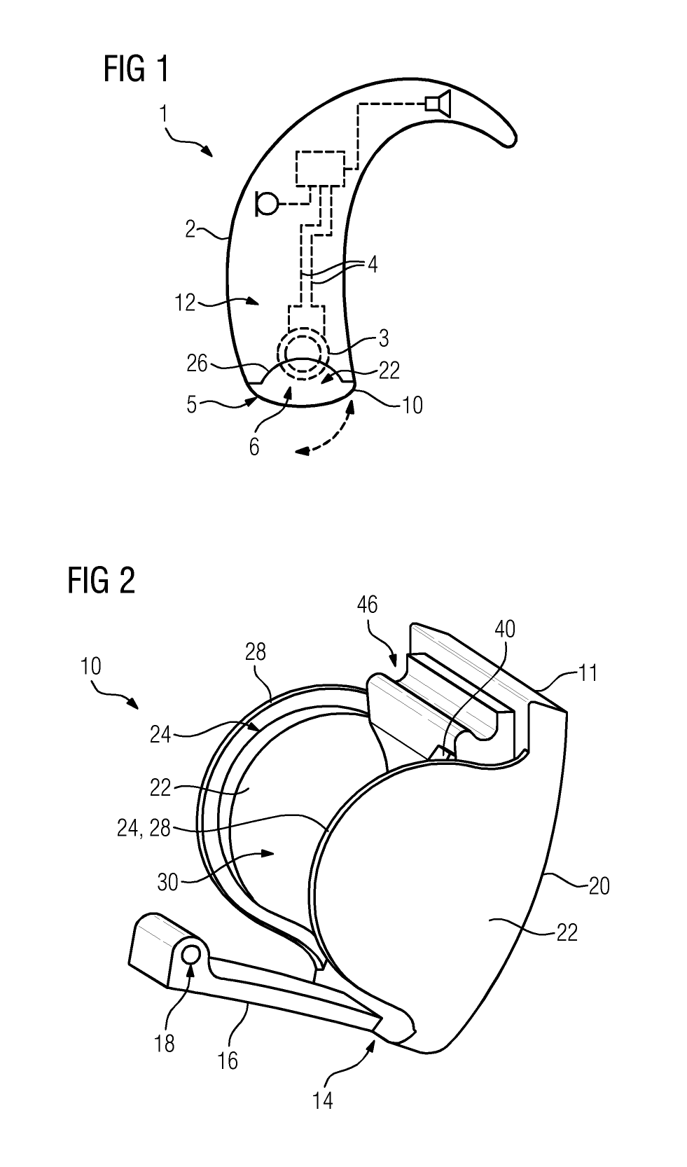

Referring now to the figures of the drawings in detail and first, particularly to FIG. 1 thereof, there is shown a schematic view of a hearing aid 1 which is configured as a behind-the-ear hearing aid. The hearing aid 1 contains several electronic components, for example a microphone, a control and evaluation unit for processing sound signals detected by the microphone, and a loudspeaker for forwarding the processed sound signals to an ear of a person wearing the hearing aid. These electronic components are arranged in a housing 2 of the hearing aid 1. To supply energy to the electronic components, a battery configured as a button cell 3 is arranged in the housing 2 and, during operation of the hearing aid 1, is in contact with the electronic components by use of electrical contacts 4. To be able to replace the button cell 3 after it has run empty, the housing 2, at an end thereof referred to herein below as front end 5, has a slot-like opening through which the button cell 3 can be pushed into the housing 2. The opening is referred to herein below as a battery compartment 6. For repeated closure of the battery compartment 6, the hearing aid 1 contains a “cover” referred to as battery compartment door 10, which is mounted pivotably on the housing 2 in the manner of a flap or door (see double arrow in a broken line in FIG. 1).

As can be seen from FIG. 2, the battery compartment door 10 is formed by a front portion 11 which, in the closed state of the battery compartment door 10, closes the housing 2 or the battery compartment 6 at the front end 5. The front portion 11 is configured in the shape of a slightly curved rectangle and, in the closed state of the battery compartment door (see FIG. 1), extends perpendicularly with respect to a cover surface 12 of the housing 2 in the breadth direction from one narrow side of the housing 2 to the other. For pivotably coupling the battery compartment door 10 to the housing 2, a continuation designated as a bearing rocker 16 protrudes from one of the longitudinal ends 14 of the front portion 11. The bearing rocker 16 has an eye 18 at its end directed away from the front portion 11. When the battery compartment door 10 is mounted as intended on the housing 2, this eye 18, in cooperation with a bearing pin, permits (in a manner not shown in detail) a pivot connection (also designated as a pivot joint) with the housing 2. The axis of the eye 18 thus forms the pivot axis for the battery compartment door 10 during opening and closing. Moreover, the battery compartment door 10 is formed by two approximately semicircular brackets which extend from the two longitudinal sides 20 of the front portion 11, perpendicularly with respect to the latter and parallel to each other. With their outer surface, these brackets provide a grip surface by which the battery compartment door 10 can be easily gripped during opening and closing, and they are therefore referred to herein below as grip wings 22.

The battery compartment door 10 is produced completely, i.e. in one piece, from a (single) material, specifically by plastic injection molding.

In order to minimize additional outlay in terms of material and design, a sealing and closing contour 24 is formed (respectively) on the grip wings 22. In the closed state of the battery compartment door 10, this sealing and closing contour 24 permits a fluid-tight connection between the battery compartment door 10 and the housing 2, specifically an edge 26 of the battery compartment 6, with a retaining force at the same time being established between battery compartment door 10 and housing 2. Therefore, the hearing aid 1 does not have any additional sealing elements, nor any fastening devices, for example pawls or notched levers, that would have to be unlocked manually in order to open the battery compartment door 10.

The sealing and closing contour 24 is here configured in the manner of a rabbet, i.e. with a step in the wall thickness direction. The edge 26 of the battery compartment 6 has a matching configuration. This results in a multi-angled contact face between the sealing and closing contour 24 and the edge 26 of the battery compartment, which in turn leads to an increased liquid creepage path (by comparison with a butt joint or a simple overlap) and thus to an enhanced sealing action in the closed state of the battery compartment door 10. Specifically, the battery compartment door 10 lies with a flange-like projection (referred to in short as flange 28) of the sealing and closing contour 24 from the outer side in a complementary recess 29 of the edge 26. The sealing and closing contour 24 is dimensioned in such a way that, in the closed state of the battery compartment door 10, the two flanges 28 bear with an interference fit on the edge 26 and thus with an increased contact pressure (by comparison with a clearance fit). In other words, the distance between the inner faces of the two flanges 28 is less than the distance between the outer faces of the two recesses 29. A frictional force is thus generated between the edge 26 and the sealing and closing contour 24, in their common contact face, and leads to a clamping and holding action of the battery compartment door 10 on the housing 2. Moreover, the interference fit also enhances the sealing action of the sealing and closing contour 24 with respect to the housing 2.

The housing 2 of the hearing aid 1 is injection molded from plastic, specifically from ABS. In order now to further enhance the sealing action of the sealing and closing contour 24 in a simple way, the battery compartment door 10 is injection molded from a plastic which is softer than ABS and thus more flexible (with a lower Shore hardness), specifically PE-LD. This advantageously allows the respective sealing and closing contour 24 to nestle particularly snugly and sealingly on the edge 26, and uniformly along the full length of the latter. In addition to a good sealing action, the softer plastic also has the effect that the housing 2 is not damaged by repeated opening and closing of the battery compartment door 10.

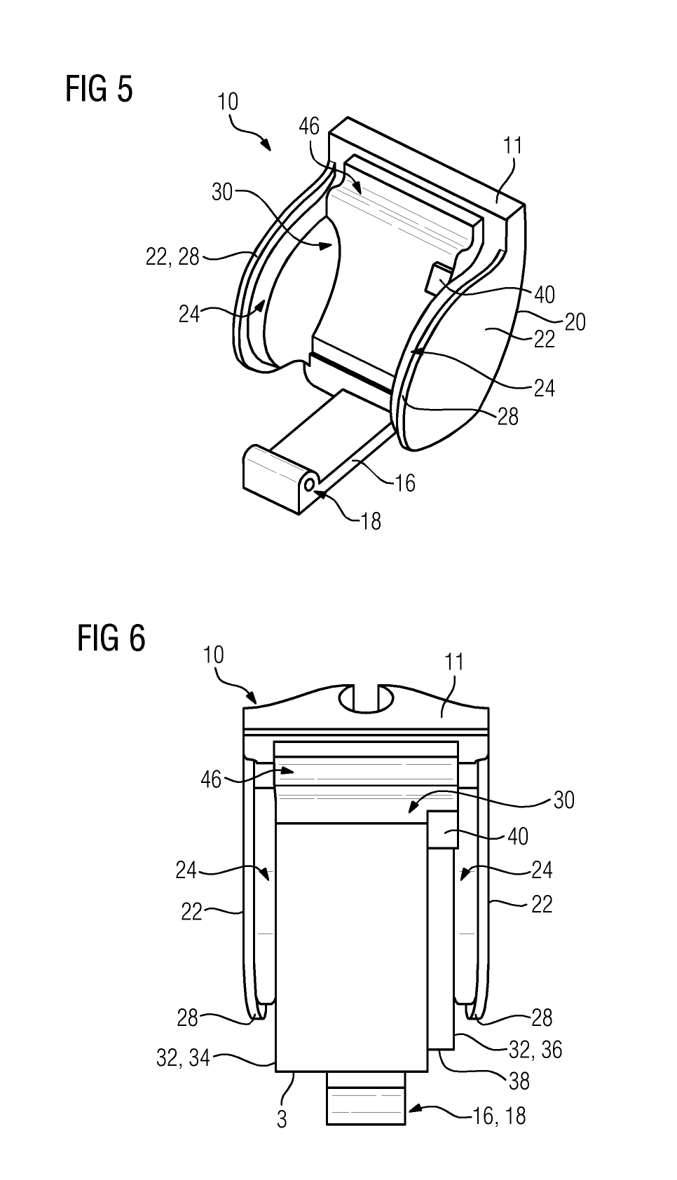

In addition to permitting the reversible closure of the battery compartment 6, the battery compartment door 10 also serves to remove the button cell 3 from the battery compartment 6. As is known, the two grip wings 22 and the front portion 11 bound an interior 30 (at least on three sides). The button cell 3 is intended to be placed into this interior 30 (with the battery compartment door 10 open; see FIG. 4 and FIG. 6) and, upon closure of the battery compartment door 10, is then automatically inserted into the battery compartment 6 and, upon opening of the battery compartment door 10, is accordingly withdrawn from the battery compartment 6. The act of opening the battery compartment door 10 also serves to switch off the electronic components of the hearing aid 1, such that an additional ON/OFF button can be dispensed with. So as not to lose the button cell 3 when the battery compartment door 10 is opened, the grip wings 22 are spaced apart from each other such that they exert a clamping action on the button cell 3. For this purpose, the distance between the two (inner faces of the) grip wings 22 is slightly smaller than the height of the button cell 3.

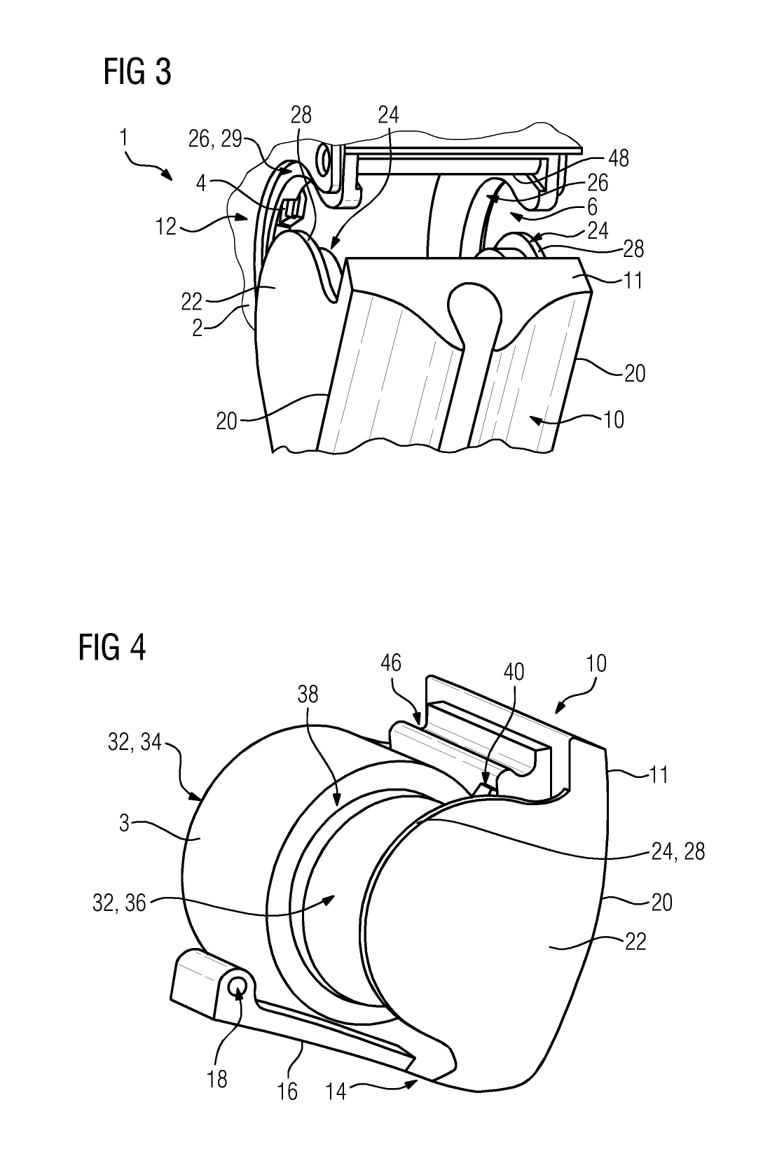

The length of the grip wings 22 is also shorter than the diameter of the button cell 3, such that the latter, when correctly fitted in place, protrudes with its two end faces 32 above the grip wings 22. Since the positive pole (cathode 34) and the negative pole (anode 36) are arranged respectively on the two end faces 32 of the button cell 3, it is possible, upon closure of the battery compartment door 10, for both poles, i.e. cathode 34 and anode 36, to be easily contacted by the electrical contacts 4 (see FIG. 1 and FIG. 3) arranged in the battery compartment 6.

As can be seen in FIG. 4 and FIG. 6, the button cell 3 has a reduced diameter (referred to herein below as neck 38) at the transition from its circumferential surface to the anode 36. To ensure that the button cell 3 can always be fitted into the interior 30 of the battery compartment door 10 the same way (and correctly) with respect to the orientation of its poles 34, 36, a shoulder 40, matching the shape of the neck 38, is formed at the transition from the inner face of the front portion 11 to the grip wing 22, of which the inner face is intended to bear on the anode 36. Thus, it is only when it is in the correct orientation that the button cell 3 can be pushed so far into the interior 30 that it bears with its circumferential surface on the inner face of the front portion 11. By contrast, in the reverse (“wrong”) orientation, the button cell 3 would protrude so far out of the interior 30 that the battery compartment door 10 would not be able to be correctly closed.

FIG. 6 shows the correct state of insertion of the button cell 3 in the interior 30, and it therefore also shows how the shoulder 40 bears on the neck 38.

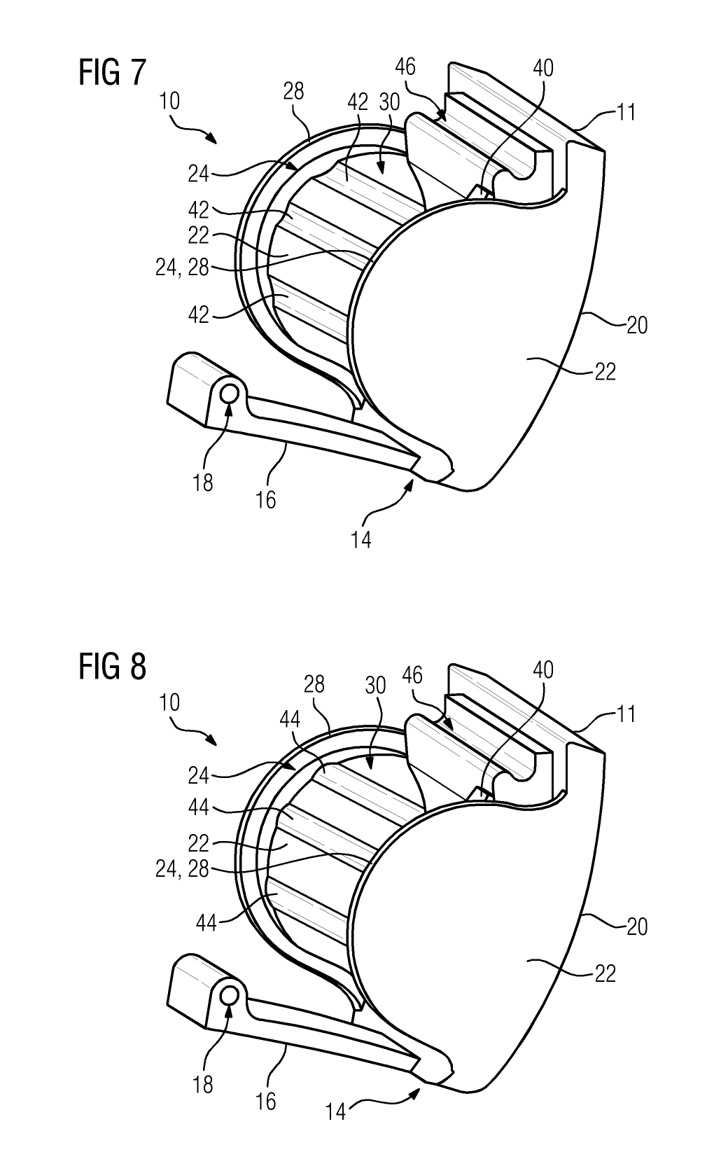

The button cell 3 is a zinc air battery, which requires a supply of atmospheric oxygen in order to generate electrochemical energy. For this purpose, on the anode 34, air inlet openings are introduced (in a manner not shown in detail) into the end face 32 assigned to the anode. To permit particularly good ventilation of the air inlet openings during the operation of the hearing aid 1, i.e. when the button cell 3 is placed in the battery compartment door 10 and pushed into the battery compartment 6, an expedient illustrative embodiment as shown in FIG. 7 is proposed in which three ribs 42 are formed on the inner face of the grip wing 22 directed toward the anode 34, and the end face 32 of the button cell 3 bears on said three ribs 42. The ribs 42 permit back ventilation of the end face 32 and, therefore, a particularly good supply of oxygen to the air inlet openings of the button cell 3.

As an equivalent to the ribs 42, provision is made, in a further illustrative embodiment as shown in FIG. 8, for the back ventilation of the button cell 3 to be improved by grooves 44 that are introduced into the inner face of the corresponding grip wing 22. In both cases, i.e. both in the case of the ribs 42 and also in the case of the grooves 44, the end face 32 of the button cell 3 does not therefore bear on the whole surface of the inner face of the grip wing.

In order, in addition to the sealing and closing contour 24, to obtain a retaining action between the battery compartment door 10 and the housing 2, the battery compartment door 10 has a latch element in the form of a latch groove 46. The latch groove 46 can be seen in FIG. 2 and in FIGS. 4 to 8. The latch groove 46 is designed and provided to be brought into locking engagement, in the closed state of the battery compartment door 10, with a pin (see FIG. 3) referred to as latch pin 48 and arranged in the battery compartment 6. As can be seen in FIG. 3, neither the latch groove 46 nor the latch pin 48 is accessible from outside the hearing aid 1 in the closed state of the battery compartment door 10. When the battery compartment door 10 is being opened, the latch groove 46 releases the latch pin 48 solely on account of elastic deformation under the effect of the opening force exerted on the grip wings 22, and therefore no separate operation of the latch groove 46 or of the latch pin 48 is required. This elastic deformation is made particularly smooth by the battery compartment door 10 being made of a plastic that is flexible by comparison with the housing 2.

In an illustrative embodiment not shown in detail, the latch groove 46 on the battery compartment door 10 is not present, and, similarly, the latch pin 48 in the battery compartment 6 is also not present.

In a further illustrative embodiment of the battery compartment door 10 not shown in detail, the inner faces of the two grip wings 22 have a concave curvature, with the result that, when the button cell 3 is inserted and the grip wings 22 are gripped, the applied gripping pressure causes the edges of the grip wings 22, i.e. the respective sealing and closing contour 24, in particular the respective flange 28 thereof, to bend outward. This allows the sealing and closing contour 24 to slide particularly easily onto and off of the edge 26.

The subject matter of the invention is not limited to the illustrative embodiments described above. Rather, further embodiments of the invention can be derived from the above description by a person skilled in the art. In particular, the individual features of the invention and the design variants thereof that have been described with reference to the various illustrative embodiments can also be combined with one another in another way.

1. A hearing aid, comprising:
a housing;
a battery compartment integrated in said housing for receiving a battery and having an edge; and
a battery compartment door for reversibly closing said battery compartment, said battery compartment door having a sealing and closing contour which, in a closed state of said battery compartment door, is in contact with said edge of said battery compartment and provides a holding action with said housing, said sealing and closing contour having increased flexibility compared to said housing, and said sealing and closing contour is produced in one piece with said battery compartment door.

2. The hearing aid according to claim 1, wherein said battery compartment door is made from a material that is softer when compared to a material forming said housing.

3. The hearing aid according to claim 1, wherein said battery compartment door is made from a same material as said housing, and said flexibility of said sealing and closing contour is increased by a reduced wall thickness compared to said housing.

4. The hearing aid according to claim 1, wherein said sealing and closing contour, in the closed state of said battery compartment door, bears on said housing in a manner of an interference fit.

5. The hearing aid according to claim 1, wherein said sealing and closing contour and said housing are formed as a rabbet such that, in the closed state of said battery compartment door, a scarf joint is formed by said sealing and closing contour and said housing.

6. The hearing aid according to claim 1, wherein said battery compartment door has:
a front portion extending in a direction of a thickness of said housing; and
two grip wings protruding substantially perpendicularly from said front portion, said grip wings, at their edge directed away from said front portion, carry said sealing and closing contour.

7. The hearing aid according to claim 6, wherein said grip wings are disposed substantially parallel to each other and at such a distance from each other that the battery is held by a clamping action between said grip wings.

8. The hearing aid according to claim 6, wherein an interior formed between said grip wings is configured in such a way that the battery can be inserted into said interior with a clear orientation of its poles.

9. The hearing aid according to claim 6, wherein said grip wings, in their longitudinal extent, are shorter than a diameter of the battery configured as a button cell battery.

10. The hearing aid according to claim 7, further comprising a back ventilator disposed on an inner face of one of said two grip wings, said inner face being directed toward one of two poles of the battery in a correct operating state, such that the battery does not bear with its pole completely on said inner face.
